(19) United States
(12) Patent Application Publication
(10) Pub. No.: US 2024/0407608 A1
(43) Pub. Date: Dec. 12, 2024

(54) Spoon Rest Device

(71) Applicant: Christy Licato, Lake Arrowhead, CA (US)

(72) Inventor: Christy Licato, Lake Arrowhead, CA (US)

(21) Appl. No.: 18/734,467

(22) Filed: Jun. 5, 2024

Related U.S. Application Data
(60) Provisional application No. 63/506,692, filed on Jun. 7, 2023.

(51) Int. Cl. A47J 47/16

(52) U.S. Cl. CPC A47J 47/16

(57) ABSTRACT

A disposable spoon rest device is disclosed that provides users with multiple, disposable spoon rests that are easily accessible. The disposable spoon rest device comprises a body component configured in the shape of a spoon rest. The body component is typically made of wax paper and comes as a bundle, like sticky notes. Generally, up to 50 individual spoon rests are stacked together. Once the top spoon rest has been used, it may be removed to reveal a fresh spoon rest. Further, the wax paper ensures the spoon or spatula will not stick to the device and can be easily reused for stirring or serving food while cooking.

### CROSS-REFERENCE TO RELATED APPLICATION

The present application claims priority to, and the benefit of, U.S. Provisional Application No. 63/506,692, which was filed on Jun. 7, 2023, and is incorporated herein by reference in its entirety.

### FIELD OF THE INVENTION

The present invention relates generally to the field of disposable spoon rest devices. More specifically, the present invention relates to a stack of wax paper layers shaped like a spoon rest, used for supporting a spoon while cooking. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in disposable spoon rest devices. Generally, people who use spoons, spatulas, and other utensils for cooking may need a place to store them while food is on the stove. Further, some people may opt to place the used utensil on a paper towel which can be messy and end up sticking to the utensil itself. Additionally, placing the utensil on the stovetop or counter can leave a mess that requires extra cleanup.

During cooking, the user often must stir or otherwise manipulate a foodstuff, leaving food particles and other residue, often in liquid form, on the head of a spoon or other cooking utensil. While the user is preparing other ingredients, the spoon or other cooking utensil often must be set aside to leave the user's hands free. Laying the cooking utensil directly on a kitchen counter, for example, will result in the soiling and contamination of the kitchen counter by the food particles and/or liquids that remain on the cooking utensil. Although a user may use a plate or bowl for supporting the utensil during cooking, typical plates and bowls are generally much larger than the cooking utensil, thus wasting counter space, and causing general inefficiency in the cooking process. Further, the plate and bowl will later have to be cleaned, thus adding to the time the user must spend in the kitchen, and wasting other resources, such as water, electricity, soap, etc. Also, some people will prepare a cup of instant coffee, a cup of tea, a cup of cocoa, or the like, using a spoon to stir the beverage, and set the spoon aside to be used again if another cup is desired. In such cases, it would be desirable to have a rest or other support on the countertop to avoid staining the countertop and the necessity for subsequent cleanup. Thus, a disposable utensil rest solving the aforementioned problems is desired.

Accordingly, there is a demand for an improved disposable spoon rest device that eliminates the need to constantly wash and dry spoon rests. More particularly, there is a demand for a disposable spoon rest device that allows users to place the spoon inside the device and prevent food and liquid from staining a countertop or stove.

Therefore, there exists a long felt need in the art for a disposable spoon rest device that provides users with a stack of wax paper layers shaped like a spoon rest, used for supporting a spoon while cooking. There is also a long felt need in the art for a disposable spoon rest device that allows users to place the spoon inside the rest to prevent food and liquid from staining a countertop or stove. Further, there is a long felt need in the art for a disposable spoon rest device that includes up to 50 layers of wax paper such that when the topmost layer is used, the user can peel away the layer to reveal a clean one ready for storing a spoon. Moreover, there is a long felt need in the art for a device that eliminates the need to constantly wash and dry reusable spoon rests or use paper towels to prevent a mess. Further, there is a long felt need in the art for a disposable spoon rest device that utilizes wax paper to prevent a spoon from sticking to the device during use. Finally, there is a long felt need in the art for a disposable spoon rest device that can be available in different quantities and sizes.

The subject matter disclosed and claimed herein, in one embodiment thereof, comprises a disposable spoon rest device. The device provides users with multiple, disposable spoon rests that are easily accessible. The disposable spoon rest device comprises a body component configured in the shape of a spoon rest. The body component is typically made of wax paper and comes as a bundle, like sticky notes. Generally, up to 50 individual spoon rests are stacked together. Once the top spoon rest has been used, it may be removed to reveal a fresh spoon rest. Further, the wax paper ensures the spoon or spatula will not stick to the device and can be easily reused for stirring or serving food while cooking.

In this manner, the disposable spoon rest device of the present invention accomplishes all of the forgoing objectives and provides users with a device that eliminates the need to constantly wash reusable spoon rests. The device is a grouping of wax paper spoon rests which can be removed and disposed of after use. The device can be manufactured of wax paper.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a disposable spoon rest device. The device provides users with multiple, disposable spoon rests that are easily accessible. The disposable spoon rest device comprises a body component configured in the shape of a spoon rest. The body component typically comes as a bundle, with a plurality of body components bound together. Once the top layer has been used, it may be removed to reveal a fresh layer.

In one embodiment, the disposable spoon rest device allows users to place a spoon, spatula, or other cooking utensil on the device to prevent foods and liquids from staining a countertop or stovetop. Thus, users are able to eliminate the need to constantly wash and dry reusable spoon rests or the need to use paper towels to prevent a mess. Specifically, the disposable spoon rest device protects a surface, such as a kitchen countertop, stovetop, etc., from direct contact with a cooking utensil, such as a spoon, a spatula, etc. Further, it should be understood that a spoon is shown for exemplary purposes only and that the device may be used with any suitable desired cooking or eating utensil as is known in the art. During cooking, the user often must stir or otherwise manipulate a foodstuff, leaving food particles and other residue, often in liquid form, on the head of the spoon. The disposable spoon rest device provides a protective surface for receiving the head of the spoon (and supporting the handle portion of the spoon), thus preventing the aforementioned food particles and residue from soiling the clean kitchen countertop, stovetop, etc.

In one embodiment, the disposable spoon rest device comprises a body component configured in the shape of a conventional spoon rest. Specifically, a plurality of body components are configured as a stack of conventional spoon rests and bundled together, much like a pad of conventional sticky notes to be used then disposed of. Thus, the body component is sized and shaped to fit within a conventional spoon rest for use. As the body component is shown as having the shape of a conventional spoon rest in the drawings, it should be understood that this is for exemplary purposes only and that the disposable spoon rest device may have any suitable shape and size as is known in the art. Further, the disposable spoon rest device may include any desired ornamentation and may have any desired dimensions as is known in the art, depending on the needs and/or wants of a user.

In one embodiment, the body component comprises a top surface which is concave, a bottom surface which is convex, rounded sidewalls forming an oval-like structure, and a stem or handle component. Further, the top surface comprises a raised peripheral rim around the top surface. In use, the head of a spoon rests on the top surface, while the handle portion of the spoon is supported by the stem component of the body component. Further, the raised peripheral rim is formed about the entire periphery of the top surface, thus preventing food-related particulates and liquids that fall from the spoon from leaving the top surface (in the form of spills, etc.) and soiling the countertop and/or stovetop, and also preventing the spoon from falling off of the device and onto the countertop and/or stovetop during use.

In one embodiment, a plurality of body components are configured as a stack and bundled together, much like a pad of sticky notes. Generally, up to fifty individual body components are stacked together to form the bundle, but any suitable number of body components can be bundled together as is known in the art. The body component is semi-rigid and sufficiently flexible to bend or flex for removal from the bundle without losing its substantially spoon rest shape. Further, once the top body component has been used, it may be removed to reveal a fresh body component. In one embodiment, all of the body components have an adhesive base on their bottom surface which allows them to be removably stuck together in a bundle then pulled apart, as needed.

In one embodiment, the top surface of the body component comprises a plurality of ridges or grooved portions. Thus, the plurality of ridges or grooved portions allow for the collection of liquids and foods from the cooking utensil resting on the body component. In use, the head of the spoon or other utensil would rest within the plurality of ridges or grooved portions for the collection of liquids and food particulate matter in the troughs of the ridges/grooves, during use, to prevent the spillage of the liquids or food matter.

In one embodiment, the body component is formed of wax paper or other suitable non-stick, disposable material. Further, the wax paper ensures that the spoon or spatula will not stick to the device and can be easily reused for stirring or serving food while cooking.

In one embodiment, the body components are typically comprised of wax paper, but could also comprise an absorbent material in their center. The absorbent material is used to remove and absorb liquids off of used spoons and the wax paper prevents the spoon from sticking to the surface of the body component when used. The absorbent material can be made from medium grade paper and ultra-thin absorbent material in the center so that it can absorb more stains than other available absorbing pads. Accordingly, the device prevents the spoon rest from becoming dirty due to spoon stains. Therefore, the present invention will reduce the amount of time users must spend washing and cleaning their spoon rests or holders.

In one embodiment, the body component comes in different designs, sizes, and shapes, so that it may also be used as a decorative device and not placed within a spoon rest but used on its own on the stovetop or countertop.

In use, the bundle of body components are positioned within a conventional spoon rest on a stovetop or countertop. Specifically, the bottom surface of the body component is positioned on the exterior surface of the conventional spoon rest and the head of a cooking utensil (i.e., spoon or spatula, etc.) is positioned against the top surface of the body component, with the handle portion of the cooking utensil being supported on the stem component of the body component. Once a soiled spoon or spatula is placed on the stack of body components during use, the first body component layer can be removed and disposed of after use, revealing a clean body component underneath. Thus, whenever the outer body component layer is used, it can be torn off and removed. Specifically, each body component layer is disposed of after use, revealing a new, clean body component for use, as needed.

In yet another embodiment, the disposable spoon rest device comprises a plurality of indicia.

In yet another embodiment, a method of eliminating the need to constantly wash and dry reusable spoon rests is disclosed. The method includes the steps of providing a disposable spoon rest device comprising a body component made of wax paper and configured in a bundle of approximately 50 spoon rests. The method also comprises positioning the device on a reusable spoon rest on a stovetop or countertop, as needed. Further, the method comprises placing a soiled spoon or spatula on the device during use. Finally, the method comprises removing the first layer of the bundle to reveal a fresh layer for use.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the disposable spoon rest device of the present invention showing the device in use on a stovetop in accordance with the disclosed architecture;

FIG. 2 illustrates a perspective view of one embodiment of the disposable spoon rest device of the present invention showing the device placed on a stovetop in accordance with the disclosed architecture;

FIGS. 3A-B illustrate a perspective view of one embodiment of the disposable spoon rest device of the present invention showing how the device is used and then the first layer peeled away in accordance with the disclosed architecture;

FIG. 4 illustrates a perspective view of one embodiment of the disposable spoon rest device of the present invention showing the top layer removed and disposed of in accordance with the disclosed architecture;

FIG. 5 illustrates a perspective view of one embodiment of the disposable spoon rest device of the present invention in use in accordance with the disclosed architecture; and

FIG. 6 illustrates a flowchart showing the method of eliminating the need to constantly wash and dry reusable spoon rests in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a disposable spoon rest device that provides users with a stack of wax paper layers shaped like a spoon rest, used for supporting a spoon while cooking. There is also a long felt need in the art for a disposable spoon rest device that allows users to place the spoon inside the rest to prevent food and liquid from staining a countertop or stove. Further, there is a long felt need in the art for a disposable spoon rest device that includes up to 50 layers of wax paper such that when the topmost layer is used, the user can peel away the layer to reveal a clean one ready for storing a spoon. Moreover, there is a long felt need in the art for a device that eliminates the need to constantly wash and dry reusable spoon rests or use paper towels to prevent a mess. Further, there is a long felt need in the art for a disposable spoon rest device that utilizes wax paper to prevent a spoon from sticking to the device during use. Finally, there is a long felt need in the art for a disposable spoon rest device that can be available in different quantities and sizes.

The present invention, in one exemplary embodiment, is a novel disposable spoon rest device. The disposable spoon rest device comprises a body component configured in the shape of a spoon rest. The body component is typically made of wax paper and comes as a bundle, like sticky notes. Generally, up to 50 individual spoon rests are stacked together. Once the top spoon rest has been used, it may be removed to reveal a fresh spoon rest. The present invention also includes a novel method of eliminating the need to constantly wash and dry reusable spoon rests. The method includes the steps of providing a disposable spoon rest device comprising a body component made of wax paper and configured in a bundle of approximately 50 spoon rests. The method also comprises positioning the device on a reusable spoon rest on a stovetop or countertop, as needed. Further, the method comprises placing a soiled spoon or spatula on the device during use. Finally, the method comprises removing the first layer of the bundle to reveal a fresh layer for use.

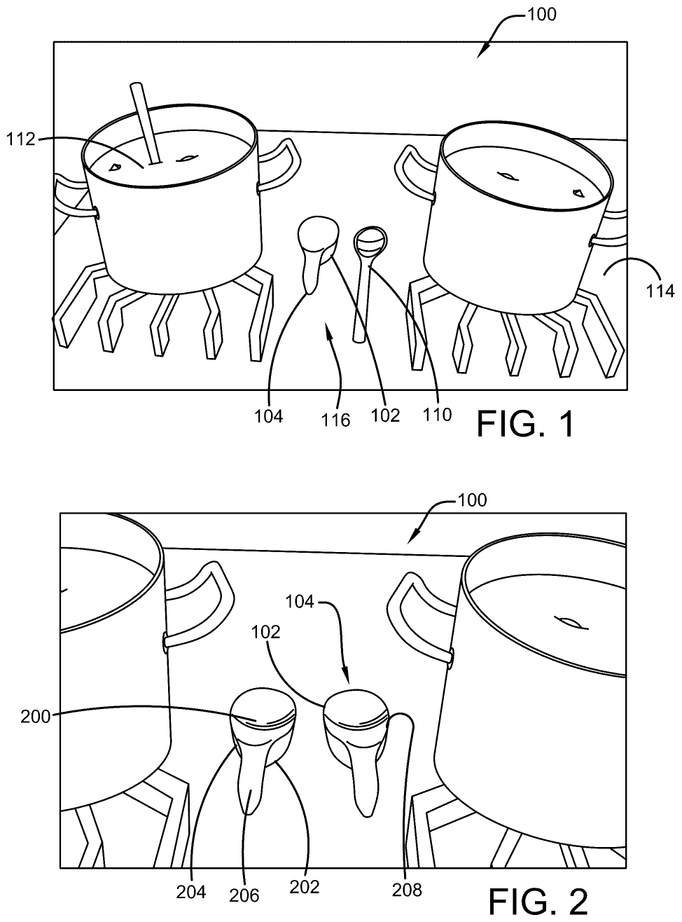

Referring initially to the drawings, FIG. 1 illustrates a perspective view of one embodiment of the disposable spoon rest device 100 of the present invention. In the present embodiment, the disposable spoon rest device 100 is an improved disposable spoon rest device 100 that provides a user with multiple, disposable spoon rests that are easily accessible. Specifically, the disposable spoon rest device 100 comprises a body component 102 configured in the shape of a spoon rest 104. The body component 102 typically comes as a bundle, with a plurality of body components 102 bound together. Once the top layer 106 has been used, it may be removed to reveal a fresh layer 108.

Generally, the disposable spoon rest device 100 allows users to place a spoon 110, spatula, or other cooking utensil on the device 100 to prevent foods and liquids 112 from staining a countertop 114 or stovetop 116. Thus, users are able to eliminate the need to constantly wash and dry reusable spoon rests 104 or the need to use paper towels to prevent a mess. Specifically, the disposable spoon rest device 100 protects a surface, such as a kitchen countertop 114, stovetop 116, etc., from direct contact with a cooking utensil, such as a spoon 110, a spatula, etc. Further, it should be understood that a spoon 110 is shown for exemplary purposes only and that the device 100 may be used with any suitable desired cooking or eating utensil as is known in the art. During cooking, the user often must stir or otherwise manipulate a foodstuff 112, leaving food particles and other residue, often in liquid form, on the head of the spoon 110. The disposable spoon rest device 100 provides a protective surface for receiving the head 118 of the spoon 110 (and supporting the handle portion 120 of the spoon 110), thus preventing the aforementioned food particles 112 and residue from soiling the clean kitchen countertop 114, stovetop 116, etc.

As shown in FIG. 2, the disposable spoon rest device 100 comprises a body component 102 configured in the shape of a conventional spoon rest 104. Specifically, a plurality of body components 102 are configured as a stack of conventional spoon rests 104 and bundled together, much like a pad of conventional sticky notes to be used then disposed of. Thus, the body component 102 is sized and shaped to fit within a conventional spoon rest 104 for use. As the body component 102 is shown as having the shape of a conventional spoon rest 104 in the drawings, it should be understood that this is for exemplary purposes only and that the disposable spoon rest device 100 may have any suitable shape and size as is known in the art. Further, the disposable spoon rest device 100 may include any desired ornamentation and may have any desired dimensions as is known in the art, depending on the needs and/or wants of a user.

Further, the body component 102 comprises a top surface 200 which is concave, a bottom surface 202 which is convex, rounded sidewalls 204 forming an oval-like structure, and a stem 206 or handle component. Further, the top surface 200 comprises a raised peripheral rim 208 around the top surface 200. In use, the head 118 of a spoon 110 rests on the top surface 200, while the handle portion 120 of the spoon 110 is supported by the stem component 206 of the body component 102. Further, the raised peripheral rim 208 is formed about the entire periphery of the top surface 200, thus preventing food-related particulates and liquids 112 that fall from the spoon 110 from leaving the top surface 200 (in the form of spills, etc.) and soiling the countertop 114 and/or stovetop 116, and also preventing the spoon 110 from falling off of the device 100 and onto the countertop 114 and/or stovetop 116 during use.

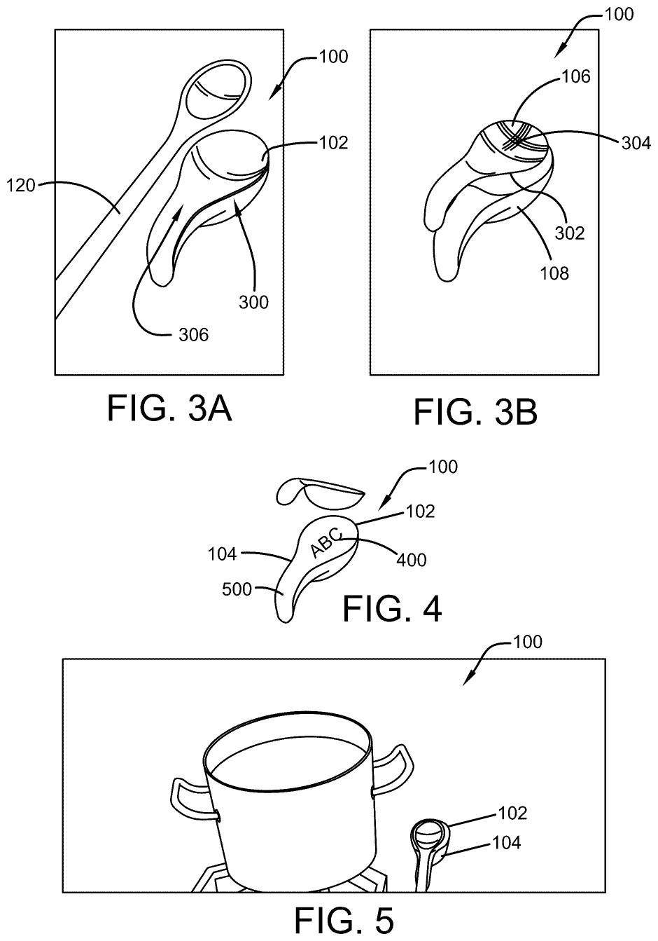

As shown in FIGS. 3A-B and 4, a plurality of body components 102 are configured as a stack and bundled together, much like a pad of sticky notes. Generally, up to fifty individual body components 102 are stacked together to form the bundle 300, but any suitable number of body components 102 can be bundled together as is known in the art. The body component 102 is semi-rigid and sufficiently flexible to bend or flex for removal from the bundle 300 without losing its substantially spoon rest shape. Further, once the top body component layer 106 has been used, it may be removed to reveal a fresh body component layer 108. In one embodiment, all of the body components 102 have an adhesive base 302 on their bottom surface 202 which allows them to be removably stuck together in a bundle 300 then pulled apart, as needed.

Further, the top surface 200 of the body component 102 comprises a plurality of ridges or grooved portions 304. Thus, the plurality of ridges or grooved portions 304 allow for the collection of liquids and foods 112 from the cooking utensil 110 resting on the body component 102. In use, the head 118 of the spoon 110 or other utensil would rest within the plurality of ridges or grooved portions 304 for the collection of liquids and food particulate matter 112 in the troughs of the ridges/grooves 304, during use, to prevent the spillage of the liquids or food matter 112.

In one embodiment, the body component 102 is formed of wax paper 306 or other suitable non-stick, disposable material. Further, the wax paper 306 ensures that the spoon 110 or spatula will not stick to the device 100 and can be easily reused for stirring or serving food 112 while cooking.

In another embodiment, the body components 102 are typically comprised of wax paper 306 but could also comprise an absorbent material 308 in their center. The absorbent material 308 is used to remove and absorb liquids 112 off of used spoons 110 and the wax paper 306 prevents the spoon 110 from sticking to the surface of the body component 102 when used. The absorbent material 308 can be made from medium grade paper and ultra-thin absorbent material in the center so that it can absorb more stains than other available absorbing pads. Accordingly, the device 100 prevents the spoon rest 104 from becoming dirty due to spoon stains. Therefore, the present invention will reduce the amount of time users must spend washing and cleaning their spoon rests 104 or holders.

In yet another embodiment, the disposable spoon rest device 100 comprises a plurality of indicia 400. The body component 102 of the device 100 may include advertising, a trademark, or other letters, designs, or characters, printed, painted, stamped, or integrated into the body component 102, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be gravestone, memory, or brand related.

As shown in FIG. 5, in use, the bundle 300 of body components 102 are positioned within a conventional spoon rest 104 on a stovetop 116 or countertop 114. Specifically, the bottom surface 202 of the body component 102 is positioned on the exterior surface 500 of the conventional spoon rest 104 and the head 118 of a cooking utensil (i.e., spoon 110 or spatula, etc.) is positioned against the top surface 200 of the body component 102, with the handle portion 120 of the cooking utensil 110 being supported on the stem component 206 of the body component 102. Once a soiled spoon 110 or spatula is placed on the stack of body components 102 during use, the first body component layer 106 can be removed and disposed of after use, revealing a clean body component layer 108 underneath. Thus, whenever the outer body component layer 106 is used, it can be torn off and removed. Specifically, each body component layer 106 is disposed of after use, revealing a new, clean body component 108 for use, as needed.

In one embodiment, the body component 102 comes in different designs, sizes, and shapes, so that it may also be used as a decorative device and not placed within a spoon rest 104 but used on its own on the stovetop 116 or countertop 114.

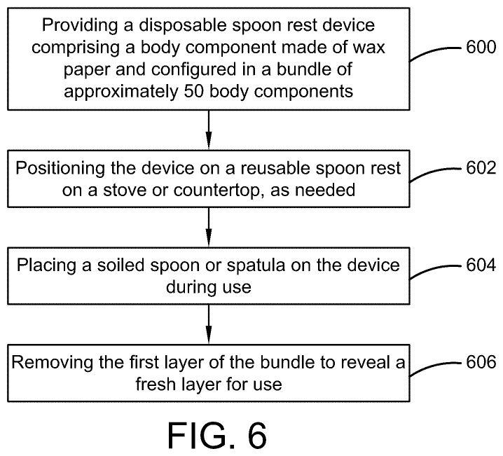

FIG. 6 illustrates a flowchart of the method of eliminating the need to constantly wash and dry reusable spoon rests. The method includes the steps of at 600, providing a disposable spoon rest device comprising a body component made of wax paper and configured in a bundle of approximately 50 spoon rests. The method also comprises at 602 positioning the device on a reusable spoon rest on a stovetop or countertop, as needed. Further, the method comprises at 604, placing a soiled spoon or spatula on the device during use. Finally, the method comprises at 606, removing the first layer of the bundle to reveal a fresh layer for use.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “disposable spoon rest device”, “spoon rest device”, “disposable device”, and “device” are interchangeable and refer to the disposable spoon rest device 100 of the present invention.

Notwithstanding the forgoing, the disposable spoon rest device 100 of the present invention can be of any suitable size and configuration as is known in the art without affecting the overall concept of the invention, provided that it accomplishes the above stated objectives. One of ordinary skill in the art will appreciate that the disposable spoon rest device 100 as shown in FIGS. 1-6 is for illustrative purposes only, and that many other sizes and shapes of the disposable spoon rest device 100 are well within the scope of the present disclosure. Although the dimensions of the disposable spoon rest device 100 are important design parameters for user convenience, the disposable spoon rest device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A disposable spoon rest device that provides a user with multiple, disposable spoon rests that are easily accessible, the disposable spoon rest device comprising:
a body component;
wherein the body component is configured as a bundle, with a plurality of body components bound together;
wherein users place a cooking utensil on the body component to prevent foods and liquids from staining a countertop or stovetop; and
further wherein once a top layer of the bundle is soiled, the top layer is removed to reveal a fresh layer for use.

2. The disposable spoon rest device of claim 1, wherein the cooking utensil is a cooking spoon or a spatula.

3. The disposable spoon rest device of claim 2, wherein the body component provides a protective surface for receiving a head of the cooking spoon and supporting a handle portion of the cooking spoon.

4. The disposable spoon rest device of claim 3, wherein the body component is configured in a shape of a conventional spoon rest and fits within the conventional spoon rest during use.

5. The disposable spoon rest device of claim 4, wherein the body component comprises a top surface which is concave, a bottom surface which is convex, rounded sidewalls forming an oval-like structure, a stem component, and a raised peripheral rim around the top surface.

6. The disposable spoon rest device of claim 5, wherein in use, the head of the cooking spoon rests on the top surface, while the handle portion of the cooking spoon is supported by the stem component of the body component.

7. The disposable spoon rest device of claim 6, wherein the raised peripheral rim is formed about an entire periphery of the top surface, thus preventing food-related particulates and liquids from the cooking spoon from leaving the top surface and soiling the countertop and stovetop.

8. The disposable spoon rest device of claim 7, wherein up to fifty individual body components are stacked together to form the bundle.

9. The disposable spoon rest device of claim 8, wherein the body component is semi-rigid and sufficiently flexible to bend or flex for removal from the bundle without losing its substantially spoon rest shape.

10. The disposable spoon rest device of claim 9, wherein the body components each have an adhesive base on their bottom surface which allows them to be removably stuck together in a bundle then pulled apart, as needed.

11. The disposable spoon rest device of claim 10, wherein the top surface of the body component comprises a plurality of ridges or grooved portions for collection of liquids and foods from the cooking spoon.

12. The disposable spoon rest device of claim 11, wherein the body component is formed of wax paper.

13. A disposable spoon rest device that provides a user with multiple, disposable spoon rests that are easily accessible, the disposable spoon rest device comprising:
a body component configured in a shape of a conventional spoon rest and fits within the conventional spoon rest during use; and
wherein the body component is configured as a bundle, with a plurality of body components bound together;
wherein up to fifty individual body components are stacked together to form the bundle;
wherein the body components each have an adhesive base on their bottom surface which allows them to be removably stuck together in a bundle then pulled apart, as needed;
wherein the body component comprises a top surface which is concave, a bottom surface which is convex, rounded sidewalls forming an oval-like structure, a stem component, and a raised peripheral rim around the top surface;
wherein the raised peripheral rim is formed about an entire periphery of the top surface, thus preventing food-related particulates and liquids from the cooking utensil from leaving the top surface and soiling the countertop and stovetop;
wherein the body component provides a protective surface for receiving a head of the cooking spoon and supporting a handle portion of the cooking utensil;
wherein users place the cooking utensil on the body component to prevent foods and liquids from staining a countertop or stovetop; and
further wherein once a top layer of the bundle is soiled, the top layer is removed to reveal a fresh layer for use.

14. The disposable spoon rest device of claim 13, wherein the body component is semi-rigid and sufficiently flexible to bend or flex for removal from the bundle without losing its substantially spoon rest shape.

15. The disposable spoon rest device of claim 13, wherein the body component is formed of wax paper.

16. The disposable spoon rest device of claim 15, wherein the body component is comprised of wax paper but could also comprise an absorbent material in their center, to remove and absorb liquids off of used cooking spoons.

17. The disposable spoon rest device of claim 13 further comprising a plurality of indicia.

18. The disposable spoon rest device of claim 13, wherein the top surface of the body component comprises a plurality of ridges or grooved portions for collection of liquids and foods from the cooking spoon.

19. The disposable spoon rest device of claim 13, wherein the body component comes in different designs, sizes, and shapes, so that it may also be used as a decorative device and not placed within a spoon rest but used on its own on the stovetop or countertop.

20. A method of eliminating the need to constantly wash and dry reusable spoon rests, the method comprising the following steps:
providing a disposable spoon rest device comprising a body component made of wax paper and configured in a bundle of approximately 50 body components;
positioning the device on a reusable spoon rest on a stovetop or countertop, as needed;
placing a soiled spoon or spatula on the device during use; and
removing the first layer of the bundle to reveal a fresh layer for use.
